(19) United States
(12) Patent Application Publication
(10) Pub. No.: US 2013/0050392 A1
(43) Pub. Date: Feb. 28, 2013

(54) SURVEILLANCE SYSTEM AND CONTROLLING METHOD THEREOF

(71) Applicant: Chin-Yi Chiang, New Taipei City (TW)

(72) Inventor: Chin-Yi Chiang, New Taipei City (TW)

(73) Assignee: Wishtek Technology, New Taipei City (TW)

(21) Appl. No.: 13/400,758

(22) Filed: Feb. 21, 2012

(30) Foreign Application Priority Data
Aug. 29, 2011 (TW) 100130940

(51) Int. Cl. H04N 7/14; H04N 7/18

(52) U.S. Cl. 348/14.01; 348/159; 348/E07.085; 348/E07.077

(57) ABSTRACT

A surveillance system includes a controlling terminal and a remote-controlled terminal. The controlling terminal and the remote-controlled terminal are connected to a network and execute an identical instant messenger software. The remote-controlled terminal includes plural cameras serving as plural video sources of the instant messenger software. A first video source of the plural video sources is a selected video source. A controlling method for the surveillance system includes steps: (a) receiving a control message by the instant messenger software of the remote-controlled terminal, and (b) judging whether the control message is a specified control message, wherein if the control message is the specified control message, the selected video source is changed from the first video source to a second video source of the plural video sources according to the specified control message.

This application claims the benefit of Taiwan Patent Application No. 100130940, filed Aug. 29, 2011, the subject matter of which is incorporated herein by reference.

### FIELD OF THE INVENTION

The present invention relates to a surveillance system, and more particularly to a surveillance system using an instant messenger software. The present invention also relates to a controlling method for such a surveillance system.

### BACKGROUND OF THE INVENTION

With increasing development of networking techniques and image processing techniques, the images shown on a network video/audio device may be monitored by a computer host through the network connection. A typical network video/audio device includes for example an internet protocol camera, an IP camera, or the like. In a case that a network video/audio device at a terminal of the network generates a video stream, the video stream may be received by a computer host at another terminal of the network. Consequently, the network video/audio device and the computer host collaboratively define a remote surveillance system.

FIG. 1 schematically illustrates the architecture of a conventional surveillance system. As shown in FIG. 1, the surveillance system 100 comprises four IP cameras 110, 112, 114 and 116, which are connected to a network 120. The IP cameras 110, 112, 114 and 116 are individual devices and located at different installation positions. In a case that a computer host 130 is connected to the network and served as a surveillance host, the user may input the IP addresses of the IP cameras 110, 112, 114 and 116 through a web browser. Consequently, the video signals from the IP cameras 110, 112, 114 and 116 can be monitored by the computer host 130. Under this circumstance, the surveillance system 100 is established.

As known, for installing the surveillance system 100, each of the IP cameras 110, 112, 114 and 116 should have a fixed IP address. That is, the four IP cameras 110, 112, 114 and 116 should have four fixed IP addresses. The computer host 130 may login into the IP cameras 110, 112, 114 and 116 according to the four fixed IP addresses, thereby receiving corresponding video streams. However, if the IP address of any of the IP cameras 110, 112, 114 and 116 is changed, the computer host 130 fails to successfully logic into this IP camera. Under this circumstance, the video signal from this IP camera fails to be monitored by the computer host 130.

Nowadays, the broadband networks provided by most network service providers use floating IP addresses to manage the network connection. As known, it costs more money to apply for the fixed IP addresses. In other words, the uses of the fixed IP addresses for establishing the surveillance system may increase the cost of the surveillance system.

For reducing the cost of installing the surveillance system, a dynamic domain name system (also referred to as DDNS) is used to solve the drawbacks of the floating IP addresses. When the DDSN service is used and the floating IP address is changed, the new IP addresses will be automatically updated to the DDNS service server. After a specified domain name is inputted by the user through the web browser, the computer host 130 is in communication with the IP cameras according to the floating IP addresses. Under this circumstance, the floating IP addresses have benefits similar to the fixed IP addresses.

In other words, although the IP address may be changed at each use time, after the specified domain name is transmitted to the DDNS service server, the floating IP address has benefits similar to the fixed IP address. Moreover, by means of the DDNS service, the IP cameras 110, 112, 114 and 116 may be connected to four floating IP address to establish the conventional surveillance system 100.

However, the method of setting and installing the above surveillance system should be performed by the technical persons familiar with the networking knowledge. Since ordinary user is usually unfamiliar to the approach of applying for the specified domain name, it is difficult for the ordinary user to establish the surveillance system. Moreover, if the DDNS service is unstable, the computer host 130 may fail to be in communication with the IP cameras through the specified domain name.

Recently, an instant messenger software (e.g. Skype, MSN, Yahoo Messenger, Google talk or QQ) is widely used and installed in a large number of personal computers. Once two personal computers are connected to the network and login into the instant messenger server, these two personal computers may be in communication with each other to transmit video signals, audio signals or texts by executing the instant messenger software. Since the settings of the instant messenger software are very simple, the instant messenger software can be easily operated by most users.

FIG. 2 schematically illustrates a conventional network architecture using the instant messenger software. As shown in FIG. 2, the network architecture comprises an instant messaging server 210, a first network terminal 220 and a second network terminal 230. The instant messaging server 210 is connected to a network 200. At the first network terminal 220, a first computer host 226 is in communication with the network 200 through a first router 222. At the second network terminal 230, a second computer host 236 is in communication with the network 200 through a second router 232. Moreover, the second computer host 236 is further in communication with a camera 234. Moreover, the identical instant messenger software is installed in both of the first computer host 226 and the second computer host 236. The camera 234 is a PC camera (e.g. a web camera or a USB camera).

After a first floating IP address is acquired by the first router 222, the first computer host 226 may be connected to the network 200 through the first router 222. Similarly, after a second floating IP address is acquired by the second router 232, the second computer host 236 may be connected to the network 200 through the second router 232. Once the first computer host 226 and the second computer host 236 login into the instant messaging server 210, the instant messaging server 210 can realize that the first computer host 226 and the second computer host 236 are online. Generally, a communication list related to the information about the first computer host 226 and the second computer host 236 is stored in the instant messaging server 210. According to the communication list, the first computer host 226 realizes that the second computer host 236 is online. Similarly, according to the communication list, the second computer host 236 realizes that the first computer host 226 is online.

Meanwhile, the user of the first computer host 226 may call the user of the second computer host 236, or the user of the second computer host 236 may call the user of the first computer host 226. Furthermore, the real time direct text-based communication or even the live voice or video calling action between the first computer host 226 and the second computer host 236 may be performed. In other words, the text message or video signal generated by the first computer host 226 is firstly transmitted to the instant messaging server 210, and then transmitted from the instant messaging server 210 to the second computer host 236. Similarly, the text message or video signal generated by the second computer host 236 may be firstly transmitted to the instant messaging server 210, and then transmitted from the instant messaging server 210 to the first computer host 226. In other words, the instant messaging server 210 is served as a signal transmission medium between the first computer host 226 and the second computer host 236.

For example, if the live voice or video calling operation between the first computer host 226 and the second computer host 236 is performed, since the second computer host 236 is connected to the camera 234, a video signal generated by the camera 234 (e.g. the video signal generated by capturing an object 238) and an audio signal generated by a microphone (not shown) may be transmitted from the second computer host 236 to the first computer host 226 through the instant messaging server 210. Consequently, the image of the object 238 may be shown on the screen of the camera 234, and the audio signal received by the microphone of the second computer host 236 or the microphone of the camera 234 may be outputted from a speaker (not shown) of the first computer host 226.

From the above discussions, both of the first computer host 226 and the second computer host 236 are client terminals of the instant messaging server 210. The login ID of the client terminal may be used to determine whether the client terminal logins into the instant messaging server 210 or not. Consequently, the instant messaging server 210 is in communication with the first computer host 226 or the second computer host 236 without the need of using the IP addresses of the client terminals.

However, since only one camera is employed according to a login ID of the instant messaging software, the applications of the instant messaging software are largely limited. Therefore, there is a need of providing a surveillance system under the networking architecture of the current instant messaging software.

### SUMMARY OF THE INVENTION

The present invention provides a surveillance system using an instant messenger software and a controlling method for the surveillance system. The surveillance system is capable of transmitting video signals between a monitoring host and a remote host by executing the instant messenger software without the need of realizing the IP addresses.

A first embodiment of the present invention provides a controlling method for a surveillance system. The surveillance system includes a controlling terminal and a remote-controlled terminal. The controlling terminal and the remote-controlled terminal are connected to a network and execute an identical instant messenger software. The remote-controlled terminal includes plural cameras serving as plural video sources of the instant messenger software. A first video source of the plural video sources is a selected video source. The controlling method includes steps: (a) receiving a control message by the instant messenger software of the remote-controlled terminal, and (b) judging whether the control message is a specified control message, wherein if the control message is not the specified control message, the step (a) is repeatedly done, wherein if the control message is the specified control message, the selected video source is changed from the first video source to a second video source of the plural video sources according to the specified control message.

A second embodiment of the present invention provides a controlling method for a surveillance system. The surveillance system includes a controlling terminal and a remote-controlled terminal. The controlling terminal and the remote-controlled terminal are connected to a network and execute an identical instant messenger software. The remote-controlled terminal includes plural cameras for generating plural video signals. The controlling method includes steps of: receiving at least two video signals of the plural video signals and combining the at least two video into a combined video signal by a simulated camera, and setting the simulated camera as a selected video source of the instant messenger software. If a live video calling action is performed between the controlling terminal and the remote-controlled terminal by executing the instant messenger software, transmitting the combined video signal from the remote-controlled terminal to the controlling terminal.

A third embodiment of the present invention provides a controlling method for a surveillance system. The surveillance system includes a controlling terminal and a remote-controlled terminal. The controlling terminal and the remote-controlled terminal are connected to a network and execute an identical instant messenger software. The remote-controlled terminal includes plural physical cameras and a simulated camera. The simulated camera acquires and combines video signals from the plural physical cameras into a combined video signal. The simulated camera is set as a selected video source of the instant messenger software. The controlling method includes steps of: (a) receiving a control message by the instant messenger software of the remote-controlled terminal, and (b) judging whether the control message is a specified control message, wherein if the control message is not the specified control message, the step (a) is repeatedly done, wherein if the control message is the specified control message, the combined video signal generated by the selected video source is changed according to the specified control message.

A fourth embodiment of the present invention provides a surveillance system. The surveillance system includes a controlling terminal, an instant messaging server and a remote-controlled terminal. The controlling terminal is connected to a network and executes an instant messenger software. The instant messaging server is connected to the network. The remote-controlled terminal is connected to the network, and includes a remote-controlled host and plural cameras. The remote-controlled host is connected to the network and executes the instant messenger software. A video source adjustable application program is installed in the remote-controlled host. The plural cameras are connected to the remote-controlled host and served as plural video sources of the instant messenger software. A first video source of the plural video sources is a selected video source. If a specified control message is received by the instant messenger software at the remote-controlled host, the selected video source is changed from the first video source to a second video source of the plural video sources by the video source adjustable application program according to the specified control message.

A fifth embodiment of the present invention provides a surveillance system. The surveillance system includes a controlling terminal, an instant messaging server and a remote-controlled terminal. The remote-controlled terminal is connected to the network, and includes plural cameras and a remote-controlled host. The plural cameras are used for generating plural video signals. The remote-controlled host is connected to the network and the plural cameras for receiving the plural video signals. A video combination driver or a filtering program is installed in the remote-controlled host for generating a combined video signal, and the combined video signal contains at least two of the plural video signals. If a live video calling action is performed between the controlling terminal and the remote-controlled terminal by executing the instant messenger software, the combined video signal is transmitted from the remote-controlled terminal to the controlling terminal through the instant messaging server.

A sixth embodiment of the present invention provides a surveillance system. The surveillance system includes a controlling terminal, an instant messaging server and a remote-controlled terminal. The remote-controlled terminal is connected to the network, and includes a remote-controlled host, plural physical cameras and a simulated camera. The remote-controlled host is connected to the network and executes the instant messenger software. The plural physical cameras are connected to the remote-controlled host for generating plural video signals. The simulated camera is installed in the remote-controlled host for acquiring and combining video signals from the plural physical cameras into a combined video signal, wherein the simulated camera is set as a selected video source of the instant messenger software. If a specified control message is received by the instant messenger software at the remote-controlled host, the combined video signal generated by the selected video source is changed according to the specified control message.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates the architecture of a conventional surveillance system;

FIG. 2 (prior art) schematically illustrates a conventional network architecture using the instant messenger software;

FIG. 3 schematically illustrates the architecture of a surveillance system according to a first embodiment of the present invention;

FIG. 4 schematically illustrates the architecture of a surveillance system according to a second embodiment of the present invention;

FIG. 5 schematically illustrates the architecture of a surveillance system according to a third embodiment of the present invention;

FIG. 6 is a flowchart illustrating a controlling method for a surveillance system according to an embodiment of the present invention; and

FIG. 7 is a flowchart illustrating a controlling method for a surveillance system according to another embodiment of the present invention.

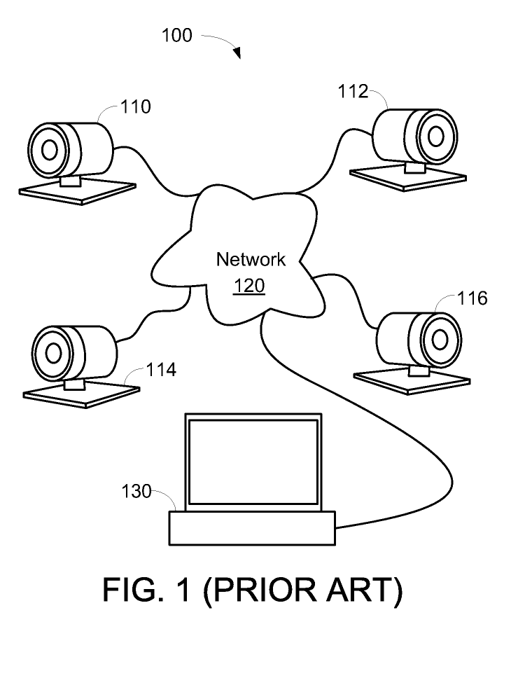

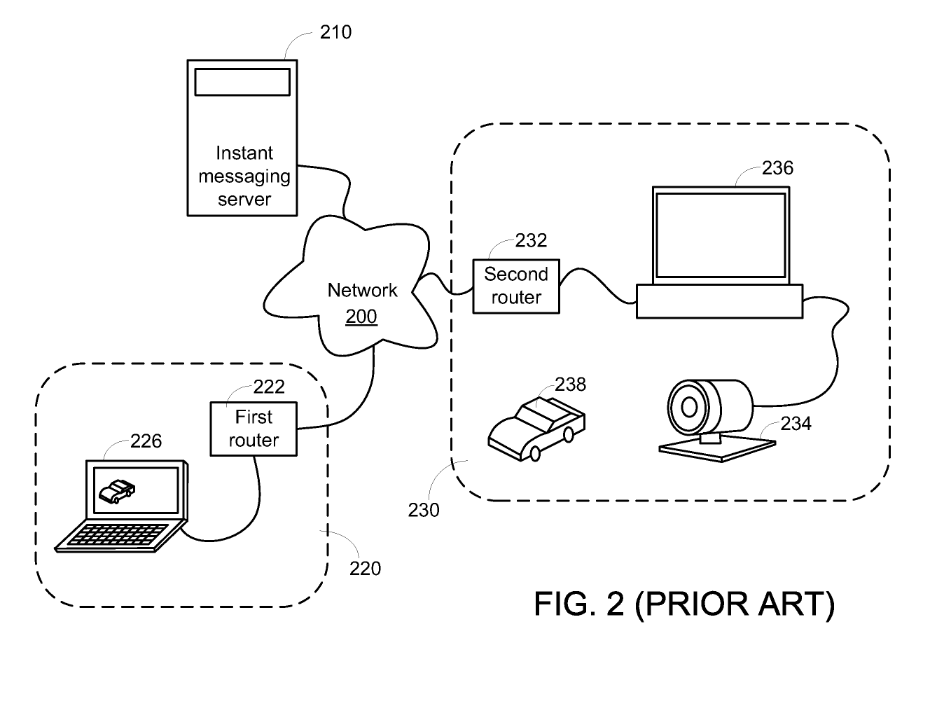

### DETAILED DESCRIPTION OF PREFERRED EMBODIMENTS

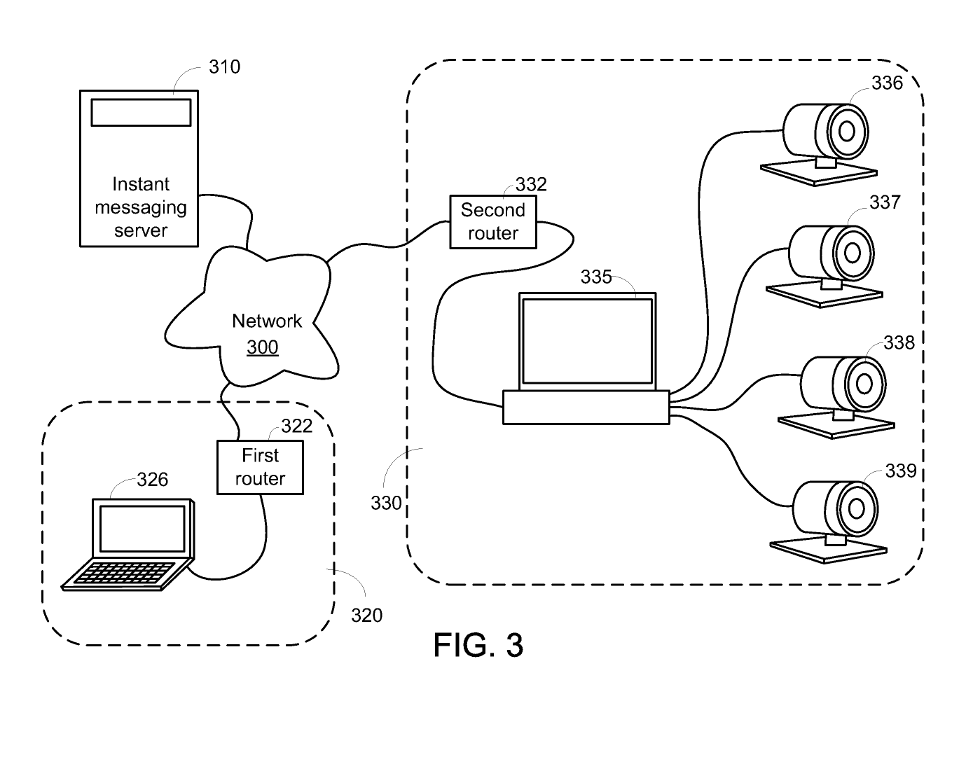

FIG. 3 schematically illustrates the architecture of a surveillance system according to a first embodiment of the present invention. As shown in FIG. 3, the surveillance system of the first embodiment comprises a network 300, an instant messaging server 310, a controlling terminal 320, and a remote-controlled terminal 330.

At the controlling terminal 320, a first computer host 326 is in communication with the network 300 through a first router 322. At the remote-controlled terminal 330, a second computer host 335 is in communication with the network 300 through a second router 332. The second computer host 335 is further in communication with plural (e.g. four) PC cameras 336, 337, 338 and 339. Moreover, an identical instant messenger software is installed in both of the first computer host 326 and the second computer host 335. In other words, the first computer host 326 at the controlling terminal 320 and the second computer host 335 at the remote-controlled terminal 330 are electronic devices capable of executing the instant messenger software. Example of the first computer host 326 and the second computer host 335 include but are not limited to personal computers, notebook computers, tablet personal computers, smart phones, TV boxes, media players, or the like.

Moreover, when a driver or a filtering program installed in the second computer host 335 is executed, the four PC cameras 336, 337, 338 and 339 are normally operated. The normal operations of the PC cameras 336, 337, 338 and 339 can be successfully detected by the second computer host 335. Since one login account of the instant messenger software is able to enable one PC camera, four video source selective items are shown on the video setting menu. Each of the video sources corresponds to one of the PC cameras 336, 337, 338 and 339. However, only a PC camera (e.g. the first PC camera 336) is a selected video source.

In a case that a live video calling action is performed between the first computer host 326 and the second computer host 335, only the video signal from the selected video source (e.g. the first PC camera 336) can be transmitted to the instant messaging server 310, and then the video signal is transmitted from the instant messaging server 310 to the first computer host 326. Consequently, the image captured by the selected video source (e.g. the first PC camera 336) is monitored by the first computer host 326. Whereas, the video signals generated by other PC cameras 337, 338 and 339 fail to be transmitted to the remote-controlled terminal 330.

Moreover, the present invention further provides a video source adjustable application program. The video source adjustable application program is installed in the second computer host 335. When the video source adjustable application program is executed, the video source selective item of the video setting menus is adjustable according to a specified control message of the instant messenger software. The control message is for example a text message, a symbol message, or a combination of a text message and a symbol message. Hereinafter, the control message is illustrated by referring to the text message.

For example, the user at the controlling terminal 320 may input a specified text message (e.g. “/*002*/”) into the instant messenger software which is executed in the first computer host 326. Through the instant messaging server 310, the specified text message is transmitted to the instant messenger software which is executed in the second computer host 335 (i.e. at the remote-controlled terminal 330). When the video source adjustable application program is executed, the video source selective item of the video setting menus is adjustable according to the specified text message “/*002*/”, and thus the second PC camera 337 is changed to be the selected video source. Meanwhile, the video signal from the second PC camera 337 can be transmitted to the instant messaging server 310, and then the video signal is transmitted from the instant messaging server 310 to the first computer host 326. Consequently, the video signal from the second PC camera 337 is monitored by the first computer host 326. Similarly, after another specified text message (e.g. “/*004*/”) is inputted by the user at the controlling terminal 320 and transmitted to the remote-controlled terminal 330, the fourth PC camera 339 is changed to be the selected video source. Consequently, the video signal from the fourth PC camera 339 may be transmitted to the controlling terminal 320.

In other words, the video source selective item of the video setting menus is adjustable by the video source adjustable application program in the second computer host 335 according to the specified text message (or the specified control message) transmitted by the instant messenger software. Consequently, the video signal from any of the PC cameras 336, 337, 338 and 339 can be monitored by the first computer host 326. Under this circumstance, the surveillance system of the present invention is established.

Moreover, in accordance with the present invention, a video combination driver or a filtering program is installed in the second computer host 335. When the video combination driver or the filtering program is executed, a simulated camera is generated. The simulated camera may be considered as a fifth video source (also referred to a simulated video source). Under this circumstance, the video setting menus of the instant messenger software contains five video source selective items. When the video combination driver or the filtering program is executed, the video signals from the PC cameras 336, 337, 338 and 339 may be selectively combined into a combined video signal.

For example, if a specified text message “/*005*01+02+03+04*/” is transmitted to the instant messenger software of the second computer host 335 at the remote-controlled terminal 330, the video setting menus is changed by the video source adjustable application program according to the specified text message, and the fifth video source is the selected video source. Moreover, the video signals from the PC cameras 336, 337, 338 and 339 are combined into a combined video signal by the video combination driver according to the specified text message “/*005*01+02+03+04*/”. The combined video signal is transmitted to the instant messaging server 310 and then transmitted to the first computer host 326. Under this circumstance, the combined video signal shown on the screen of the first computer host 326 contains the video signals from the PC cameras 336, 337, 338 and 339.

Similarly, another specified text message “/*005*01+04*/” indicates that the fifth video source is the selected video source and the video signals from the first PC camera 336 and the fourth PC camera 339 are combined into a combined video signal. The rest may be deduced by analogy.

From the above discussions, the video signal from a single PC camera or the combined video signal from plural PC cameras may be processed by the second computer host 335 according to a specified text message (or a specified control message) and then transmitted to the first computer host 326. Under this circumstance, the surveillance system of the present invention is established. The above embodiment is illustrated by referring to the specified text message. Nevertheless, those skilled in the art will readily observe that numerous modifications of the specified text message (or the specified control message) may be made while achieving the purpose of changing the video source of the instant messenger software.

Moreover, the video combination driver or the filtering program may be directly employed to generate a simulated camera, and the simulated camera may be considered as a fifth video source. In addition, the video signals from a predetermined number of PC cameras (e.g. all PC cameras) may be combined into a combined video signal. Consequently, the fifth video source may be directly set as the selected video source by the user through the video setting menus of the instant messenger software. In a case that a live video calling action is performed between the first computer host 326 and the second computer host 335, the combined video signal may be transmitted to the instant messaging server 310 without the need of using the video source adjustable application program. Then, the combined video signal is transmitted from the instant messaging server 310 to the first computer host 326, so that the combined video signal of the fifth video source is monitored by the first computer host 326. In other words, the video signals from plural PC cameras are simultaneously monitored by the first computer host 326.

From the above discussions, the image combination driver or the filtering program may be employed to receive at least two video signals and combine these video signals into a combined video signal. The simulated camera for generating the combined video signal may be set as the selected video source of the instant messenger software. Consequently, once a live video calling action is performed between the controlling terminal and the remote-controlled terminal by executing the instant messenger software, the combined video signal will be transmitted from the remote-controlled terminal to the controlling terminal.

Moreover, under the architecture of FIG. 3, the control message may be employed to change the simulated camera to generate various combined video signals. Consequently, the controlling method for the surveillance system of the present invention is established.

For example, the video combination driver or the filtering program is installed in the second computer host 335 to generate a simulated camera, and the simulated camera may be considered as a fifth video source. Consequently, the fifth video source is set as the selected video source of the instant messenger software.

For example, the user at the controlling terminal 320 may input a specified text message “/*02+04*/” into the instant messenger software which is executed in the first computer host 326. Through the instant messaging server 310, the specified text message is transmitted to the instant messenger software which is executed in the second computer host 335 (i.e. at the remote-controlled terminal 330). When the video combination driver or the filtering program is executed, the contents of the combined video signal is adjusted according to the specified text message “/*02+04*/”. That is, the video signals from the second PC camera 337 and the fourth PC camera 339 are combined into the combined video signal. The combined video signal is transmitted to the instant messaging server 310, and then transmitted from the instant messaging server 310 to the first computer host 326. Consequently, the combined video signals from the second PC camera 337 and the fourth PC camera 339 will be monitored by first computer host 326.

Similarly, according to another specified control message “/*02+03+04*/”, the video signals from the second PC camera 337, the third PC camera 338 and the fourth PC camera 339 are combined into a combined video signal by the simulated camera. The simulated camera is transmitted to the first computer host 326. Similarly, according to the specified control message “/*01*/”, the combined video signal of the simulated camera only contains the video signal from the first PC camera 336.

For performing the above controlling method, it is not necessary to change the video source of the instant messenger software. That is, after the simulated camera is set as the selected video source, the simulated camera is controlled to generate various combined video signals according to the control message. Consequently, the user at the controlling terminal 320 may utilize the control message to view the video signals from any number of PC cameras or a specified PC camera.

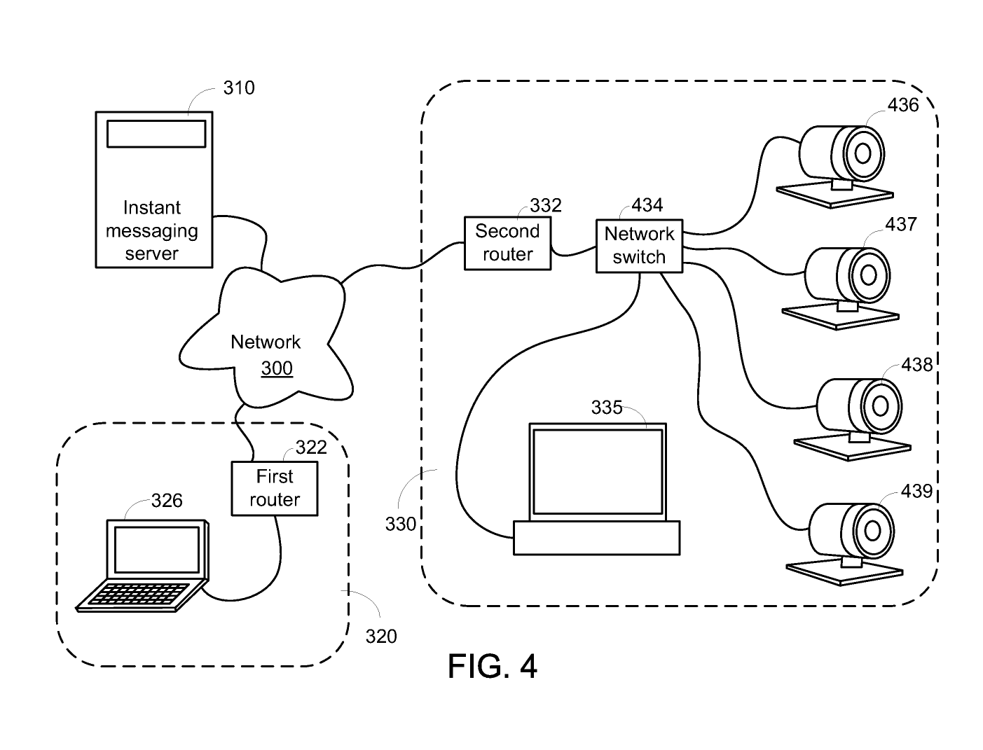

FIG. 4 schematically illustrates the architecture of a surveillance system according to a second embodiment of the present invention. As shown in FIG. 4, the surveillance system of the second embodiment comprises a network 300, an instant messaging server 310, a controlling terminal 320, and a remote-controlled terminal 330.

In comparison with the first embodiment, the remote-controlled terminal 330 is distinguished. As shown in FIG. 4, the remote-controlled terminal 330 comprises plural (e.g. four) IP cameras 436, 437, 438 and 439. Moreover, at the remote-controlled terminal 330, a network switch 434 is connected to a second router 332. The second computer host 335 and the IP cameras 436, 437, 438 and 439 are connected with plural connecting ports of the network switch 434, respectively.

Since the electronic devices of the remote-controlled terminal 330 are located at the same IP domain, when a driver or a filtering program installed in the second computer host 335 is executed, the IP addresses of the four IP cameras 436, 437, 438 and 439 can be detected by the second computer host 335. Consequently, the video signals from the four IP cameras 436, 437, 438 and 439 can be received by the second computer host 335.

Similarly, four video source selective items are shown on the video setting menu of the instant messenger software. Each of the video sources corresponds to one of the IP cameras 436, 437, 438 and 439. However, only an IP camera (e.g. the first IP camera 436) is a selected video source.

That is, when a live video calling action is performed between the first computer host 326 and the second computer host 335, only the video signal from the first IP camera 436 can be transmitted to the second computer host 335 through the network switch 434. Then, the video signal is transmitted from the second computer host 335 to the instant messaging server 310, and then transmitted from the instant messaging server 310 to the first computer host 326. Consequently, the video signal from the first IP camera 436 is monitored by the first computer host 326. Whereas, the video signals from other IP cameras 437, 438 and 439 fail to be transmitted to the remote-controlled terminal 330.

Similarly, a video source adjustable application program is installed in the second computer host 335. When the video source adjustable application program is executed, the video source selective item of the video setting menus is adjustable according to a specified text message (e.g. a specified control message) of the instant messenger software. The operations of the video source adjustable application program are similar to those illustrated in the first embodiment, and are not redundantly described herein. In other words, the video source selective item of the video setting menus is adjustable by the video source adjustable application program in the second computer host 335 according to the specified text message (or the specified control message) transmitted by the instant messenger software. Consequently, the video signal from any of the IP cameras 436, 437, 438 and 439 can be monitored by the first computer host 326. Under this circumstance, the surveillance system of the present invention is established.

Moreover, in this embodiment, a video combination driver or a filtering program is installed in the second computer host 335. When the video combination driver or the filtering program is executed, a simulated camera is generated. The simulated camera may be considered as a fifth video source (also referred to a simulated video source). Under this circumstance, the video setting menus of the instant messenger software contains five video source selective items. When the video combination driver or the filtering program is executed, the video signals from the IP cameras 436, 437, 438 and 439 may be selectively combined into a combined video signal. The operations of the video combination driver are similar to those illustrated in the first embodiment, and are not redundantly described herein.

Moreover, the video combination driver or the filtering program may be directly employed to generate a simulated camera, and the simulated camera may be considered as a fifth video source. In addition, the video signals from a predetermined number of IP cameras may be combined into a combined video signal. Under this circumstance, the fifth video source may be directly set as the selected video source by the user through the video setting menus of the instant messenger software. In a case that a live video calling action is performed between the first computer host 326 and the second computer host 335, the combined video signal may be transmitted to the instant messaging server 310 without the need of using the video source adjustable application program. Then, the combined video signal is transmitted from the instant messaging server 310 to the first computer host 326, so that the combined video signal of the fifth video source is monitored by the first computer host 326. In other words, the video signals from plural IP cameras are simultaneously monitored by the first computer host 326.

Moreover, under the architecture of FIG. 4, the control message may be employed to change the simulated camera to generate various combined video signals. Consequently, the controlling method for the surveillance system of the present invention is established. The controlling method is similar to that of the first embodiment, and is not redundantly described herein.

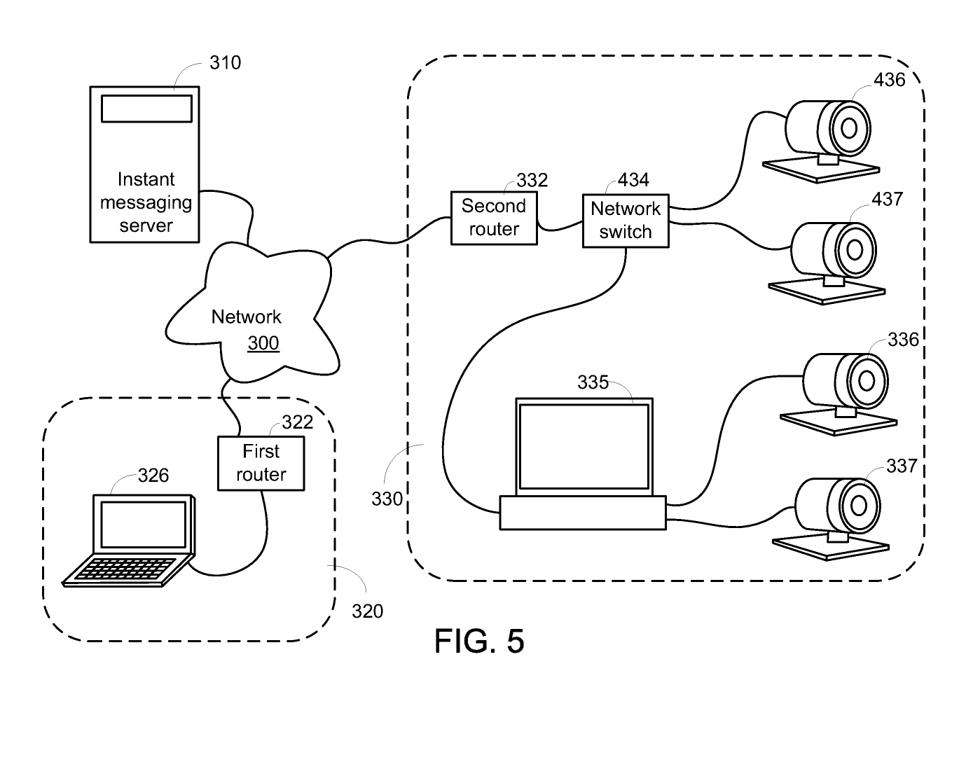

FIG. 5 schematically illustrates the architecture of a surveillance system according to a third embodiment of the present invention. As shown in FIG. 5, the surveillance system of the second embodiment comprises a network 300, an instant messaging server 310, a controlling terminal 320, and a remote-controlled terminal 330.

In comparison with the first embodiment and the second embodiment, the remote-controlled terminal 330 is distinguished. As shown in FIG. 5, the remote-controlled terminal 330 comprises plural (e.g. two) PC cameras 336, 337 and plural (e.g. two) IP cameras 436, 437. Moreover, at the remote-controlled terminal 330, a network switch 434 is connected to a second router 332. The second computer host 335 and the two IP cameras 436 and 437 are connected with plural connecting ports of the network switch 434, respectively. In addition, the PC cameras 336 and 337 are connected to the second computer host 335.

In other words, when a driver or a filtering program installed in the second computer host 335 is executed, the IP addresses of the two IP cameras 436, 437 and the PC cameras 336, 337 may be detected by the second computer host 335. The operations of the surveillance system are similar to those of the first embodiment and the second embodiment, and are not redundantly described herein.

In views of cost-effectiveness, the second router 332 and the second computer host 335 of the first embodiment may be integrated into a remote-controlled host. The remote-controlled host may only have the functions of the router and the instant messenger software. For example, the remote-controlled host is a router executing the instant messenger software. After the video source adjustable application program or the video combination driver or the filtering program is further installed in the remote-controlled host, the surveillance system of the present invention is established. Similarly, the second router 332, the network switch 434 and the second computer host 335 of the second embodiment may be integrated into a remote-controlled host. The remote-controlled host may only have the functions of the router, the network switch and the instant messenger software. After the video source adjustable application program or the video combination driver or the filtering program is further installed in the remote-controlled host, the surveillance system of the present invention is established.

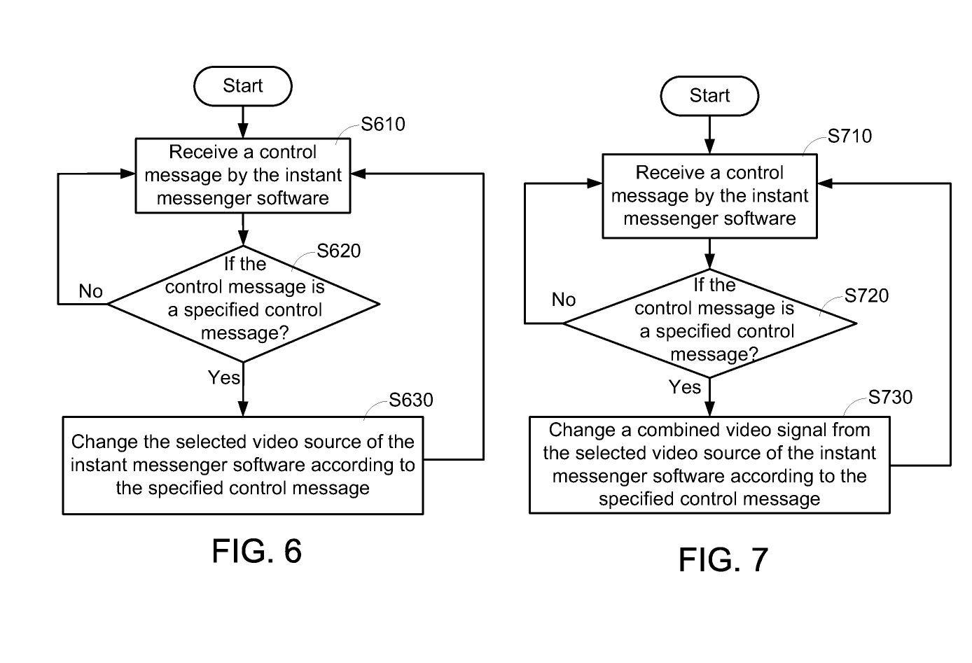

FIG. 6 is a flowchart illustrating a controlling method for a surveillance system according to an embodiment of the present invention. Firstly, in the step S610, a control message is received by the instant messenger software. Then, the step S620 is performed to judge whether the control message is a specified control message. If the control message is not the specified control message, the step S610 is repeatedly done to wait for a next control message. Whereas, if the control message is the specified control message, the selected video source in the video setting menu of the instant messenger software is changed according to the specified control message (Step S630). Then, the step S610 is repeatedly done to wait for the next control message. Of course, if the user only needs to control the video source once, after the step S630 is performed, it is not necessary to perform the step S610 again. From the above discussions, in the controlling method for the surveillance system as shown in FIG. 6, the selected video source in the video setting menu is changed according to the specified control message.

FIG. 7 is a flowchart illustrating a controlling method for a surveillance system according to another embodiment of the present invention. In this embodiment, a video combination driver or a filtering program is installed in the second computer host of the remote-controlled terminal. When the video combination driver or the filtering program is executed, a simulated camera is generated and the simulated camera is set as the selected video source. Firstly, in the step S710, a control message is received by the instant messenger software. Then, the step S720 is performed to judge whether the control message is a specified control message. If the control message is not the specified control message, the step S710 is repeatedly done to wait for a next control message. Whereas, if the control message is the specified control message, a combined video signal from the selected video source of the instant messenger software is changed according to the specified control message (Step S730). Then, the step S710 is repeatedly done to wait for the next control message. Of course, if the user only needs to control the simulated camera once, after the step S730 is performed, it is not necessary to perform the step S710 again. From the above discussions, in the controlling method for the surveillance system as shown in FIG. 7, various combined video signals are generated according to the specified control message. The combined video signal can be transmitted to the controlling terminal.

From the above description, the surveillance system of the present invention is implemented by using the free instant messenger software and a specified application program (e.g. a video source adjustable application program, a video combination driver or a filtering program). The surveillance system is advantageous over the conventional surveillance system because the complicated setting procedures are omitted. In accordance with the present invention, the video signal of any camera or the combined video signal of plural cameras can be viewed by inputting the specified control message. Consequently, the execution of the instant messenger software is not limited to operate a single video source.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A controlling method for a surveillance system, the surveillance system comprising a controlling terminal and a remote-controlled terminal, the controlling terminal and the remote-controlled terminal being connected to a network and executing an identical instant messenger software, the remote-controlled terminal comprising plural cameras serving as plural video sources of the instant messenger software, a first video source of the plural video sources being a selected video source, the controlling method comprising steps of:
(a) receiving a control message by the instant messenger software of the remote-controlled terminal; and
(b) judging whether the control message is a specified control message, wherein if the control message is not the specified control message, the step (a) is repeatedly done, wherein if the control message is the specified control message, the selected video source is changed from the first video source to a second video source of the plural video sources according to the specified control message.

2. The controlling method as claimed in claim 1, wherein if a live video calling action is performed between the controlling terminal and the remote-controlled terminal by executing the instant messenger software, a video signal generated by the selected video source is transmitted from the remote-controlled terminal to the controlling terminal.

3. The controlling method as claimed in claim 1, wherein the plural camera further comprises a simulated camera, and the plural video sources further comprises a simulated video source, wherein if the simulated video source is served as the selected video source, a combined video signal is generated by the simulated camera and transmitted from the remote-controlled terminal to the controlling terminal, wherein the combined video signal contains video signals from at least two of the plural cameras.

4. The controlling method as claimed in claim 1, wherein the control message is a text message, a symbol message, or a combination of the text message and the symbol message.

5. A controlling method for a surveillance system, the surveillance system comprising a controlling terminal and a remote-controlled terminal, the controlling terminal and the remote-controlled terminal being connected to a network and executing an identical instant messenger software, the remote-controlled terminal comprising plural cameras for generating plural video signals, the controlling method comprising steps of:
receiving at least two video signals of the plural video signals, and combining the at least two video into a combined video signal by a simulated camera; and
setting the simulated camera as a selected video source of the instant messenger software, wherein if a live video calling action is performed between the controlling terminal and the remote-controlled terminal by executing the instant messenger software, transmitting the combined video signal from the remote-controlled terminal to the controlling terminal.

6. The controlling method as claimed in claim 5, wherein the simulated camera is generated by a video combination driver or a filtering program.

7. A controlling method for a surveillance system, the surveillance system comprising a controlling terminal and a remote-controlled terminal, the controlling terminal and the remote-controlled terminal being connected to a network and executing an identical instant messenger software, the remote-controlled terminal comprising plural physical cameras and a simulated camera, the simulated camera acquiring and combining video signals from the plural physical cameras into a combined video signal, the simulated camera being set as a selected video source of the instant messenger software, the controlling method comprising steps of:
(a) receiving a control message by the instant messenger software of the remote-controlled terminal; and
(b) judging whether the control message is a specified control message, wherein if the control message is not the specified control message, the step (a) is repeatedly done, wherein if the control message is the specified control message, the combined video signal generated by the selected video source is changed according to the specified control message.

8. The controlling method as claimed in claim 7, wherein if a live video calling action is performed between the controlling terminal and the remote-controlled terminal by executing the instant messenger software, the combined video signal generated by the selected video source is transmitted from the remote-controlled terminal to the controlling terminal.

9. The controlling method as claimed in claim 7, wherein one or more video signals from the plural physical cameras are combined into the combined video signal by the simulated camera according to the control message.

10. The controlling method as claimed in claim 7, wherein the control message is a text message, a symbol message, or a combination of the text message and the symbol message.

11. A surveillance system, comprising:
a controlling terminal connected to a network and executing an instant messenger software;
an instant messaging server connected to the network; and
a remote-controlled terminal connected to the network, and comprising:
a remote-controlled host connected to the network and executing the instant messenger software, wherein a video source adjustable application program is installed in the remote-controlled host; and
plural cameras connected to the remote-controlled host and served as plural video sources of the instant messenger software, wherein a first video source of the plural video sources is a selected video source,
wherein if a specified control message is received by the instant messenger software at the remote-controlled host, the selected video source is changed from the first video source to a second video source of the plural video sources by the video source adjustable application program according to the specified control message.

12. The surveillance system as claimed in claim 11, wherein if a live video calling action is performed between the controlling terminal and the remote-controlled terminal by executing the instant messenger software, a video signal generated by the selected video source is transmitted from the remote-controlled terminal to the controlling terminal through the instant messaging server.

13. The surveillance system as claimed in claim 11, wherein the plural camera further comprises a simulated camera, and the plural video sources further comprises a simulated video source, which is generated by a video combination driver or a filtering program installed in the remote-controlled host, wherein if the simulated video source is served as the selected video source, a combined video signal is generated by the simulated camera and transmitted from the remote-controlled terminal to the controlling terminal through the instant messaging server, wherein the combined video signal contains video signals from at least two of the plural cameras.

14. The surveillance system as claimed in claim 11, wherein the controlling terminal comprises:
a first router connected to the network; and
a first computer host connected to the first router and executing the instant messenger software.

15. The surveillance system as claimed in claim 11, wherein the remote-controlled host comprises:
a second router connected to the network; and
a second computer host connected to the second router and executing the instant messenger software,
wherein the plural cameras are PC cameras and connected to the second computer host.

16. The surveillance system as claimed in claim 11, wherein the remote-controlled host comprises:
a second router connected to the network;
a network switch connected to the second router; and
a second computer host connected to the network switch and executing the instant messenger software,
wherein the plural cameras are IP cameras and connected to the network switch.

17. The surveillance system as claimed in claim 11, wherein the remote-controlled host comprises:
a second router connected to the network;
a network switch connected to the second router; and
a second computer host connected to the network switch and executing the instant messenger software,
wherein a first portion of the plural cameras are IP cameras and connected to the network switch, and a second portion of the plural cameras are PC cameras and connected to the second computer host.

18. The surveillance system as claimed in claim 11, wherein the control message is a text message, a symbol message, or a combination of the text message and the symbol message.

19. The surveillance system as claimed in claim 11, wherein the controlling terminal comprises a personal computer, a notebook computer, a tablet personal computer, a smart phone, a TV box, or a media player.

20. The surveillance system as claimed in claim 11, wherein the remote-controlled host comprises a personal computer, a notebook computer, a tablet personal computer, a smart phone, a TV box, or a media player.

21. A surveillance system, comprising:
a controlling terminal connected to a network and executing an instant messenger software;
an instant messaging server connected to the network; and
a remote-controlled terminal connected to the network, and comprising:
plural cameras for generating plural video signals; and
a remote-controlled host connected to the network and the plural cameras for receiving the plural video signals, wherein a video combination driver or a filtering program is installed in the remote-controlled host for generating a combined video signal, and the combined video signal contains at least two of the plural video signals,
wherein if a live video calling action is performed between the controlling terminal and the remote-controlled terminal by executing the instant messenger software, the combined video signal is transmitted from the remote-controlled terminal to the controlling terminal through the instant messaging server.

22. The surveillance system as claimed in claim 21, wherein the controlling terminal comprises a personal computer, a notebook computer, a tablet personal computer, a smart phone, a TV box, or a media player.

23. The surveillance system as claimed in claim 21, wherein the remote-controlled host comprises a personal computer, a notebook computer, a tablet personal computer, a smart phone, a TV box, or a media player.

24. A surveillance system, comprising:
a controlling terminal connected to a network and executing an instant messenger software;
an instant messaging server connected to the network; and
a remote-controlled terminal connected to the network, and comprising:
a remote-controlled host connected to the network and executing the instant messenger software;
plural physical cameras connected to the remote-controlled host for generating plural video signals; and
a simulated camera installed in the remote-controlled host for acquiring and combining video signals from the plural physical cameras into a combined video signal, wherein the simulated camera is set as a selected video source of the instant messenger software,
wherein if a specified control message is received by the instant messenger software at the remote-controlled host, the combined video signal generated by the selected video source is changed according to the specified control message.

25. The surveillance system as claimed in claim 24, wherein if a live video calling action is performed between the controlling terminal and the remote-controlled terminal by executing the instant messenger software, the combined video signal generated by the selected video source is transmitted from the remote-controlled terminal to the controlling terminal through the instant messaging server.

26. The surveillance system as claimed in claim 24, wherein at least one video signal from the plural physical cameras are combined into the combined video signal by the simulated camera according to the control message.

27. The surveillance system as claimed in claim 24, wherein the controlling terminal comprises:
a first router connected to the network; and
a first computer host connected to the first router and executing the instant messenger software.

28. The surveillance system as claimed in claim 24, wherein the remote-controlled host comprises:
a second router connected to the network; and
a second computer host connected to the second router and executing the instant messenger software,
wherein the plural physical cameras are PC cameras and connected to the second computer host, wherein the simulated camera is installed in the second computer by executing a video combination driver or a filtering program.

29. The surveillance system as claimed in claim 24, wherein the remote-controlled host comprises:
a second router connected to the network;
a network switch connected to the second router; and
a second computer host connected to the network switch and executing the instant messenger software,
wherein the plural cameras are IP cameras and connected to the network switch, wherein the simulated camera is installed in the second computer by executing a video combination driver or a filtering program.

30. The surveillance system as claimed in claim 24, wherein the remote-controlled host comprises:
a second router connected to the network;
a network switch connected to the second router; and
a second computer host connected to the network switch and executing the instant messenger software,
wherein a first portion of the plural cameras are IP cameras and connected to the network switch, and a second portion of the plural cameras are PC cameras and connected to the second computer host, wherein the simulated camera is installed in the second computer by executing a video combination driver or a filtering program.

31. The surveillance system as claimed in claim 24, wherein the control message is a text message, a symbol message, or a combination of the text message and the symbol message.

32. The surveillance system as claimed in claim 24, wherein the controlling terminal comprises a personal computer, a notebook computer, a tablet personal computer, a smart phone, a TV box, or a media player.

33. The surveillance system as claimed in claim 24, wherein the remote-controlled host comprises a personal computer, a notebook computer, a tablet personal computer, a smart phone, a TV box, or a media player.
